(19) United States
(12) Patent Application Publication
(10) Pub. No.: US 2006/0226575 A1
(43) Pub. Date: Oct. 12, 2006

(54) Micro-fabrication of bio-degradable polymeric implants

(76) Inventors: Mariam Maghribi, Fremont, CA (US); Zara Sieh, Pleasanton, CA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/100,751

(22) Filed: Apr. 7, 2005

(51) Int. Cl. B29C 41/02; B29C 59/02; B29C 71/02; B28B 11/08; B28B 7/14; B29C 71/00

(52) U.S. Cl. 264/293; 264/163; 264/236

(57) ABSTRACT

Various methods of micro-fabricating 2-dimensional and 3-dimensional medical devices comprised of bio-degradable materials. The various methods use conventional photo-lithographic techniques commonly used in the semi-conductor or integrated circuit industry and translate those techniques to process bio-degradable medical devices. The devices may be active, passive or combination active-passive devices for controlling the release of drugs or other bio-active agents contained within the devices. Such devices may be used externally or internally for drug delivery, wound healing, tissue re-generation or the like.

### BACKGROUND OF THE INVENTION

1. Field of the Invention

The invention generally relates to systems and methods of micro-fabricating medical devices comprised of bio-degradable polymers.

2. Related Art

Micro-patterning is a technique that has long been used for patterning micro-chips, integrated circuits and the like in the computer and semiconductor industries. Methods such as ultraviolet (UV) photo-lithography, reactive ion etching, and electron beam evaporation have commonly been used as micro-patterning techniques in those industries.

More recently, patterning of substrates for biological applications has been contemplated. Fabrication methods have been developed for biological micro-chips, for example, that control the rate and time of release of drugs. The rate and time of release of the drugs may be controlled based on the type or thickness of polymer that caps one or more reservoirs provided in a micro-chip as in U.S. Pat. No. 6,123,861.

Medical devices comprised of bio-degradable polymers thus have increasing relevance with respect to drug delivery in the medical field. Devices comprised of bio-degradable polymers also have significant potential in various other fields of medicine, such as tissue engineering and in vivo sensing.

Whereas known drug delivery microchips, such as disclosed in U.S. Pat. No. 6,123,861, have polymer caps integral with an underlying substrate to comprise the device, there exists a need for systems and methods that micro-fabricates medical devices comprised of bio-degradable polymers that are independent of the underlying substrate from which the devices are molded. A further need exists for forming such bio-degradable devices in a quicker and cost effective manner.

### SUMMARY OF THE INVENTION

The systems and methods of the invention provide medical devices comprised of bio-degradable polymers. More specifically, the systems and methods of the invention provide new processes for micro-fabricating low-cost medical devices comprised of bio-degradable polymers.

According to the systems and methods of the invention, the bio-degradable polymers are formed into 2-dimensional or 3-dimensional medical devices using various techniques, such as photolithography, laser etching, mold casting or machining. Master molds used to shape the devices may be either sacrificial or permanent. The medical devices may be usable as external or implantable devices such as drug delivery, stent, orthopedic, wound healing, tissue regeneration and/or tissue scaffold devices, for example. The devices made by the systems and methods of the invention may be passive, active, or a combination of passive and active devices. Where the devices are active devices or at least partly active, the active component of the device can be either electrical, chemical, mechanical, or any combination thereof.

According to one embodiment of the systems and methods of the invention, a master mold is formed from a glass, silicon, ceramic, metal, polymer, or other patternable material including a sacrificial material, using conventional photo-lithography. The master mold generally provides 2-dimensional or 3-dimensional devices. To form 3-dimensional devices from the 2-dimensional device subsequent layers are generally added thereto using similar photo-lithographic techniques.

A bio-degradable polymer is deposited onto the 2-dimensional master mold, cured, planarized and removed therefrom to form the basic device according to the invention. Where the 2-dimensional master mold includes a pattern, such as recessed or raised areas, the bio-degradable polymer is then spun, cast or otherwise deposited onto the master mold to uniformly cover the pattern of the master mold.

The pattern of the master mold is thus inversely imparted to the bio-degradable polymer that is spun, cast or otherwise deposited onto the master mold. The patterned polymer is then cured, planarized and removed from the master mold. In either case, once removed, the device comprised of the bio-degradable polymer is stored until desired.

In some embodiments of the systems and methods of the invention, the device is a passive device in which the biodegradable polymer is impregnated with one or more drugs or bio-active agents that are released as the polymer degrades.

The polymer may or may not be patterned in this case. In other embodiments, the device is a passive device in which one or more drugs or agents are separately filled into recesses and sealingly contained within the recesses provided in the patterned polymer, or in the recesses provided in a subsequently photo-lithographically applied layer. In either of these cases a bio-degradable material seals the recessed areas, wherein the seals are photo-lithographically applied. In these embodiments with the sealed recessed areas the one or more drugs or bio-active agents are released from the recessed areas as the seal degrades. In still other embodiments, the device is a passive device in which drugs are sealingly contained within recessed areas as above, and the polymer is impregnated with one or more drugs or other agents. In this latter case, the seal and the polymer may degrade at different rates to release the drugs or other agents respectively contained therein accordingly.

In other embodiments of the systems and methods of the invention, the device is an active device wherein the polymer is impregnated with one or more drugs or other bio-active agents and is doped with conductive bio-degradable materials. In these active devices sensors are embedded within the polymer prior to curing thereof and electrodes are provided thereon after curing such that the drugs or agents contained within the polymer are released as the polymer degrades when the conductive materials are energized by the electrodes. In still other embodiments, the device is an active device in which the one or more drugs or agents are sealingly contained within sealed recesses provided in the patterned polymer or in a subsequent photo-lithographically applied layer, as before. In these latter embodiments, the seals may be partially comprised of conductive materials, sensors are embedded within the seals and electrodes are placed thereon, similar to as before. The one or more drugs or agents contained within the recesses are released as the seal degrades when the conductive materials are energized by the electrodes to degrade the seal. A combination of a conductively bio-degradable seal with a conductively bio-degradable polymer may also be used to release one or more drugs or agents upon degradation of the seal and the polymer. An electric voltage signal may be used to energize the conductive materials to degrade the polymer, the seal, or both.

In yet other embodiments of the systems and methods of the invention, the device is a combination active and passive device, wherein the polymer is impregnated with the one or more drugs or other agents to form a passive component of the device, and a conductive bio-degradable seal is provided to contain one or more drugs or agents within the sealed recessed areas provided in the patterned polymer or in a subsequent photo-lithographically provided layer. As before, an electric voltage signal may be used to degrade the conductive materials of the seal to release the drugs or agents from the recessed areas, whereas the drugs or other agents in the impregnated polymer will degrade naturally according to the polymer type and thickness used.

Still other embodiments use conventional photo-lithographic techniques to micro-fabricate 3-dimensional non-planar medical devices comprised of bio-degradable materials. As in the 2-dimensional planar devices, these 3-dimensional non-planar devices may be passive, active or combination passive and active devices.

The various passive, active and combination passive and active devices described herein are either 2-dimensional planar devices fabricated from the bio-degradable polymer formed by the photo-lithographically patterned master mold, 3-dimensional planar devices formed by adding subsequent layers atop the 2-dimensional planar devices, or more directly formed 3-dimensional non-planar devices whereby conventional photo-lithographic techniques are used.

The above and other features of the invention, including various novel details thereof, will now be more particularly described with reference to the accompanying drawings and claims. It will be understood that the various exemplary embodiments of the invention described herein are shown by way of illustration only and not as a limitation thereof. The principles and features of this invention may be employed in various alternative embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIGS. 1a-1d illustrate various stages of fabricating a 2-dimensional generally planar bio-degradable polymer device according to the invention.

FIGS. 2a-2b illustrate a non-patterned 2-dimensional planar polymer device fabricated according to the invention.

FIGS. 3a-3d illustrate various views of a 2-dimensional planar having sealed recesses according to the invention.

FIGS. 4a-4f illustrate various stages of a 3-dimensional planar device fabricated according to the invention.

FIGS. 5a-5d illustrate various stages of fabricating an active 2-dimensional planar device according to the invention.

FIGS. 6a-6e illustrate various stages of fabricating an active 2-dimensional device having sealed recesses according to the invention.

FIGS. 7a-7f illustrate various stages of fabricating an active 3-dimensional device having sealed recesses according to the invention.

FIG. 8 illustrates a combination active and passive device fabricated according to the invention.

FIGS. 9a-9h illustrate various stages of fabricating a non-planar 3-dimensional device according to the invention.

### DETAILED DESCRIPTION OF THE INVENTION

For purposes of the systems and methods of the invention described herein, the terms bio-degradable, bio-degradable polymer or bio-degradable materials refers to materials that are bioresorbable and/or degrade and/or break down or erode into components that are metabolizable or excretable, over a period of time, upon interaction with a physiological environment. The period of time may range from minutes to years, preferably less than one year, while maintaining the requisite structural integrity of the device in which one or more drugs, agents or other systems are incorporated. The mechanical properties of the bio-degradable materials is understood to range from hydrogels to rigid materials. Exemplary bio-degradable materials may thus comprise, but are not limited to, polyglycolic acid, polylactic acid, polycaprolactone, polydioxanone, and polyhydroxybutyrate. The bio- degradable materials may be used exclusively or in combination with one another. Where used in combination, various properties of the bio-degradable materials can be manipulated to achieve desired functions, such as rates of degradation of the bio-degradable polymeric device, by blending the combined bio-degradable materials at different ratios.

The deposition techniques of imparting the bio-degradable materials to form a medical device according to the systems and methods of the invention can range from spin coating or casting, as described in greater detail further below, although the artisan will appreciate that other techniques known in the art, such as, for example, vapor depositing, spray coating, screen printing, and inkjet deposition may also be used according to the systems and methods of the invention. The patterning of the bio-degradable polymers to form a medical device according to the systems and methods of the invention can be done by photolithography, as described in greater detail further below, or can be done by screen printing, stenciling, or inkjet deposition as the artisan should also readily appreciate.

Further, for purposes of the systems and methods of the invention described herein, where possible the same or similar reference numerals are used in the various embodiments described herein.

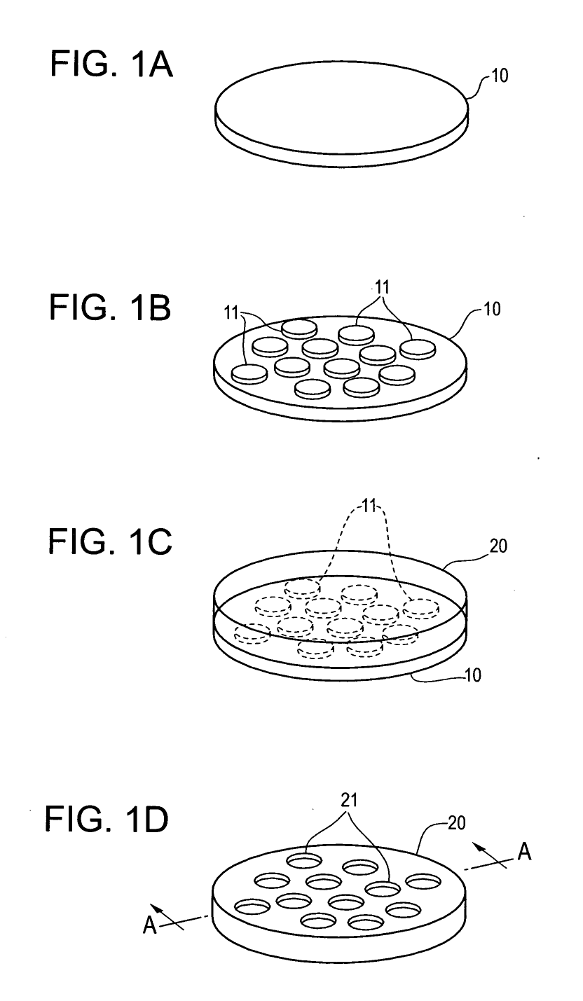

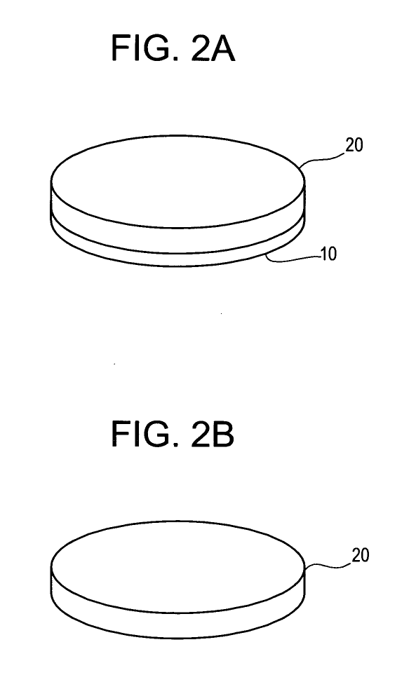

FIGS. 1a-1d illustrate a basic technique for processing a 2-dimensional planar substrate according to the invention, wherein passive, active and combination aspects of the invention will be discussed in greater detail below with respect to FIGS. 2a-7f. FIG. 1a, in particular illustrates a planar substrate 1. The substrate may be glass, silicon, ceramic, metal, polymer, or other material, including a sacrificial material, that is able to be patterned by conventional photo-lithography. Once patterned, the substrate becomes the master mold 10 that will be used to shape a bio-degradable polymer into a medical device according to the invention. The master mold 10 can be made from a 2-dimensional substrate that is built into a 2-dimensional or 3-dimensional medical device according to the systems and methods of the invention. The master mold may instead be a 3-dimensional non-planar substrate from which a 3-dimensional medical device is directly constructed as discussed in greater detail further below. In any case, the master mold may be either sacrificial or permanent, and can be made using a variety of techniques such as, but not limited to, photolithography, laser etching, mold casting or machining.

As shown in FIG. 1b, the master mold 10 may be patterned to have raised portions 11, for example. The artisan should readily appreciate that other patterns, such as channels, bumps, recesses, or the like, may also or instead be photo-lithographically imparted upon the master mold 10. The features patterned onto the master mold 10 can thus be in the plane of the substrate 1, or out of the plane of the substrate, as by being etched into the substrate, for example, as desired.

Once patterned, as shown in FIG. 1c, a bio-degradable polymer 20 is deposited onto the master mold 10. The polymer 20 is preferably spun or cast onto the patterned master mold 10 so as to uniformly cover the pattern, shown as raised portions 11 in FIGS. 1b & 1c, of the master mold 10. Preferably, the polymer is spun or cast onto the patterned master mold 10 in a thickness ranging from 500 angstroms to 200 microns, and the overall thickness of the device may therefore range from angstroms to millimeters.

The polymer 20 is then cured, planarized and removed from the mold master substrate 10. Preferably the curing of the polymer occurs under vacuum for from 2 to 24 hours. Alternatively, curing can occur by freeze-drying the polymer in the master mold 10 prior to removal therefrom.

FIG. 1d illustrates the bio-degradable polymer 20 after removal from the master mold substrate 10. The removed polymer 20 is a substantially 2-dimensional planar patterned device that exhibits the inverse of the pattern provided on the master mold substrate 10. As shown in FIG. 1d, recesses 21 are imparted to the polymer 20 as a result of the raised portions 11 of the master mold substrate 10 onto which the polymer 20 was spun or cast. The master mold substrate 10 thus determines the complexity and size of the bio-degradable polymeric device that is made.

Of course, as the artisan will appreciate, the 2-dimensional planar device according to the invention could be comprised in its simplest form as a passive device as shown in FIG. 2a & 2b, wherein the polymer is impregnated with one or more drugs or other bio-active agents as the polymer is spun or cast onto the master mold 10. Thereafter, the polymer 20 is cured, planarized and removed (FIG. 2b) from the master mold 10 and stored for future use. In use, the drugs or other agents are released as the bio-degradable polymer naturally degrades over time. Although the master mold substrate 10 is shown as patterned in FIGS. 1a-1d, the artisan will also appreciate that the master mold substrate 10 need not be patterned to form the polymeric device in its simplest form according to the invention.

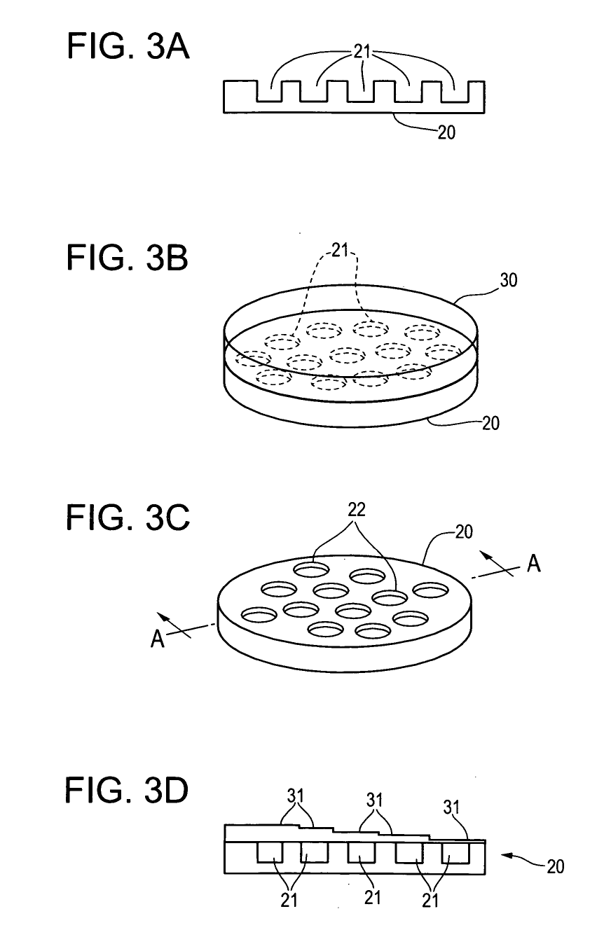

FIGS. 3a & 3c illustrate another embodiment of a passive device according to the invention. As shown in FIGS. 3a & 3b, the 2-dimensional polymer 3 formed by the patterned master mold 10 of FIGS. 1a-1d and removed therefrom is represented in cross-sectional view along the line A-A of FIG. 1d. The recesses 21 formed in the polymer 20 as a result of the master mold 10 are readily evident in upright position in FIG. 3a. After removing the polymer 20 from the master mold substrate 10, the upright recesses 21 may be separately filled with one or more drugs or other bio-active agents. Thereafter, as shown in FIGS. 3b & 3c the polymer 20 with separately filled recesses 21 is transferred to a second master mold 30 that overlies the upright polymer 20 and photo-lithographically patterns seals 31 over the filled recesses 21 of the polymer 20. The drugs or agents may be injected into the recesses using a standard micro-injection syringe, for example, as is true of all embodiments having filled recesses described herein. The seals 31 can be of varying thicknesses, as shown in cross-section along the line A-A in FIG. 3d, and are preferably comprised of bio-degradable materials. The bio-degradable materials used to comprise each of the seals 31 can be the same as, or different than, the other seals 31. In this manner, the release of the drugs or bio-active agents from the recesses 21 may be passively controlled according to the type or thickness of the materials comprising the seals 31 according to the invention.

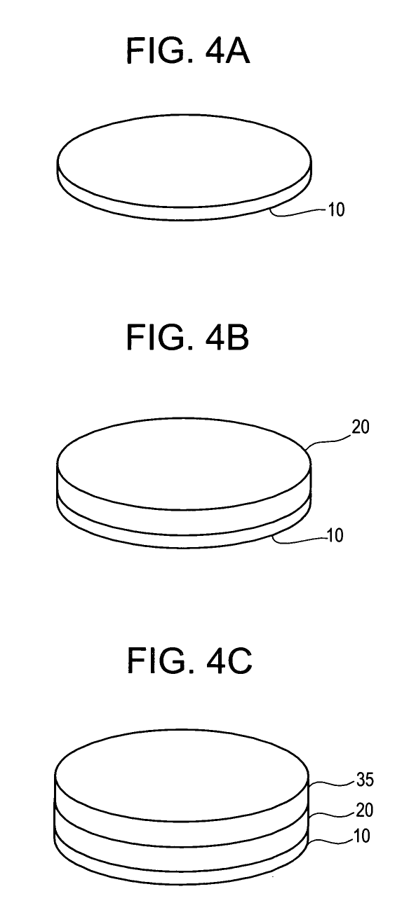

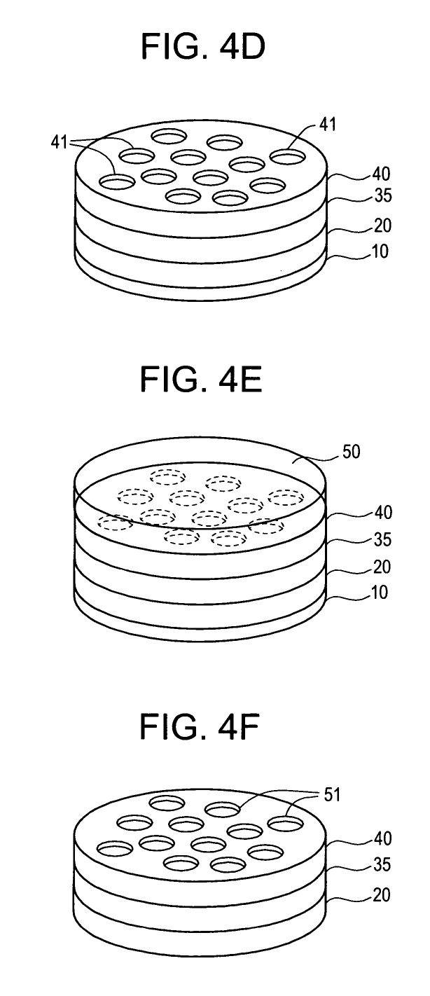

Alternatively, as shown in FIGS. 4a-4f, a passive device according to the invention is formed with recesses 41 provided in a layer 40 applied subsequent to the polymer 20. In this embodiment, the master mold 10 (FIG. 4a) need not be patterned, in which case the polymer 20 deposited thereon (FIG. 4b) is accordingly not inversely patterned by the master mold 10. Instead, the polymer 20 is deposited as an initial polymer layer on the master mold 10 and is cured and planarized while thereon. Thereafter, a metal layer 35, for example, is deposited atop the planarized surface of the initial polymer layer 30. The metal layer 35 is then cured and planarized. Thereafter, a photoresist layer 40 is then applied to the metal layer 35.

The photoresist layer 40 is then masked and exposed using conventional photo-lithography techniques to produce recessed areas 41 in the photoresist layer 40. The recessed areas 41 are then filled with one or more drugs or other bio-active agents, as desired. A second polymer layer 50 is then spun or otherwise cast over the filled recessed areas 41 to provide a seal 51 for the recessed areas The second polymer 50 is then cured and planarized and the device removed from the second mold substrate 10 similar to as in earlier embodiments. Of course if the master mold 10 is patterned, then the polymer 20 deposited thereon would be inversely patterned as before.

Photo-lithographically depositing the additional layers to the underlying 2-dimensional device in this manner is understood in the art as representing one version of a 3-dimensional device. In use, the one or more drugs or bio-active agents are thus released as the biodegradable polymer comprising the seals 51 degrade. Of course, the artisan will appreciate that the additional layers need not contain recessed areas, but could instead contain any variety of patterns as desired using the same or similar processing steps as outlined above.

A still further embodiment of a passive device according to the invention comprises impregnating the polymer 20 with one or more drugs or bio-active agents prior to curing and combining the impregnated polymer 20 with sealed recesses 21 or 41 filled with one or more drugs or bio-active agents as described above. The one or more drugs or other agents are thus released from the passive device as the bio-degradable polymer 20 and the seals 31 or 51 degrade. By design, the polymer 20 and the seals 31 or 51 may degrade at different rates, in order to control the release of the drugs and agents appropriately.

Although the passive devices described thus far have been represented as drug delivery devices, the artisan will appreciate that the devices can be designed to serve other, or additional, purposes. For example, the devices could as well be constructed as stents, tissue regeneration or scaffolding devices, wound healing or orthopedic devices. The passive devices likewise can include passive sensors incorporated into the bio-degradable polymer that cause the release of the one or more drugs or bio-active agents included within the device when a parameter in excess of a pre-set threshold is sensed. Such sensors can include hydrogel or foam based sensors or chemical based sensors, such as pH sensors.

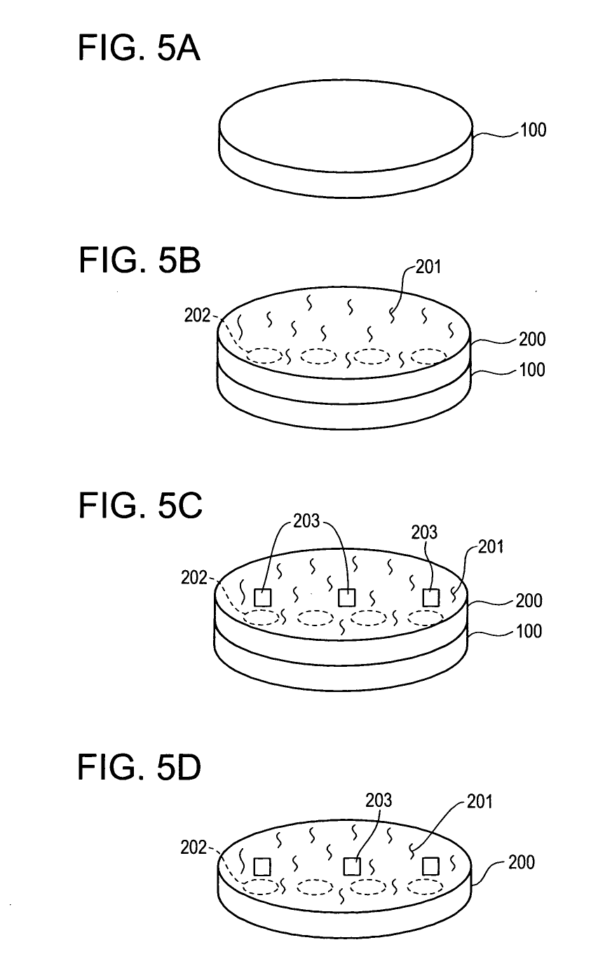

FIGS. 5a-d illustrate a technique for processing an active 2-dimensional planar device according to the invention. As in the earlier described passive device embodiments, the master mold substrate may be glass, silicon, ceramic, metal, polymer or other material, including a sacrificial material, that is able to be patterned by conventional photo-lithography to form the master mold 100. The master mold may be either sacrificial or permanent, and can be made using any of the variety of techniques as outlined above. The master mold 100 is then used to shape a bio-degradable polymer into the desired medical device according to the invention. The master mold 100 can thus be patterned or non-patterned.

In those embodiments where the device is an active 2-dimensional device without recessed areas, as shown in FIGS. 5a-5d, the bio-degradable polymer 200 may be impregnated with one or more drugs or other bio-active agents and doped with metal components 201 as electronic components in the polymer 200 prior to curing of the polymer 200. The conductive metal components can be doped into the polymer, or can be sputtered, evaporated, screen printed or inkjet printed onto the polymer. The metal components 201 are preferably bio-degradable metals such as, but not limited to, gold, titanium, platinum and carbon. Sensors 202 are embedded into the polymer 200 prior to curing of the polymer as well. After the polymer 200 has been cured and planarized, electrodes 203 are added to the planarized surface of the polymer 200. The electrodes 203 can be sputtered, evaporated, screen-printed, or inkjet deposited to the polymer 200. The impregnated polymer 200 with the metal components 201, sensors 202 and electrodes 203 is then removed from the master mold 100 and stored for future use as before. In use, the metal components 201 in the polymer 200 are conductively energized to degrade the polymer 200 and release the drugs or other agents contained therein based on an electronic signal provided to the device via the electrodes 203. The rate of drug release or other activity can thus be controlled in accordance with physiological parameters sensed by the sensors 202 such that, for example, when a sensed parameter varies from a desired threshold the electrodes 203 will be activated by a voltage signal and the conductivity of the metal components 201 in the polymer 200 will cause the polymer 200 to degrade.

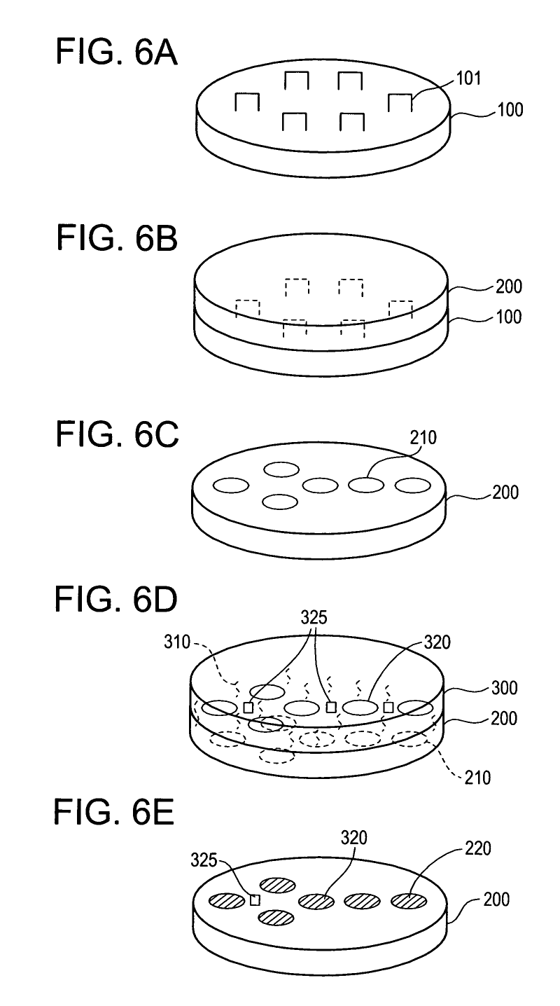

Alternatively, in those embodiments where the device is an active 2-dimensional planar device with sealed recesses, as in FIGS. 6a-6e, the master mold 100 is photo-lithographically patterned with raised areas 101. The bio-degradable polymer 200 is spun or cast onto the master mold 100 such that the inverse pattern of the master mold 100 is imparted to the bio-degradable polymer 200, when the bio-degradable polymer 200 is removed from the master mold 100. As in the passive devices (FIGS. 3a-3d) having sealed recesses 210, the inverse pattern imparted to the polymer 200 includes recesses 210. After curing, the polymer 200 with recesses 210 is removed from the master mold 100 and placed in an upright position (FIG. 6c). The patterned polymer 200 may have the upright recesses 210 filled with one or more drugs or other bio-active agents using a standard micro-injection syringe as before. Thereafter, the polymer 200 with filled recesses 210 has a second master mold 300 applied atop the polymer 200. The second master mold 300 is lined with a conductive bio-degradable material that overlies and seals 310 the recesses 210 of the molded polymer 200 when the bio-degradable material is cured. Of course, alternatively or in addition thereto, the polymer could instead be impregnated with the one or more drugs or other agents as outlined above as well.

Referring still to FIGS. 6a-6e, prior to curing the conductive bio-degradable sealing material 310, sensors 320 are embedded therein. After curing of the bio-degradable sealing material 310 electrodes 325 are provided thereon. As before, after formation of the active device in this manner, the device is removed from the master mold 100 and stored until desired. In use, therefore, the drugs or other agents contained within the recesses 210 are released when the conductive materials in the seals 310 are activated via the electrodes 325 to degrade the seals 310. The electrodes 325 are generally activated when a sufficient variation from a threshold level of a physiological parameter is sensed by one or more of the sensors 320. Of course, where the polymer is impregnated with the one or more drugs or other agents, the same are released over time as before as well.

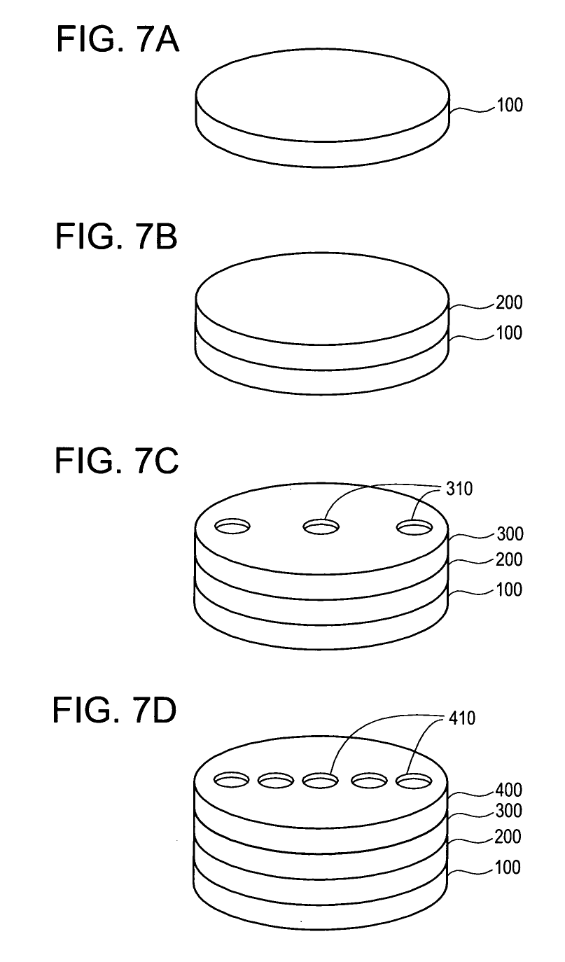

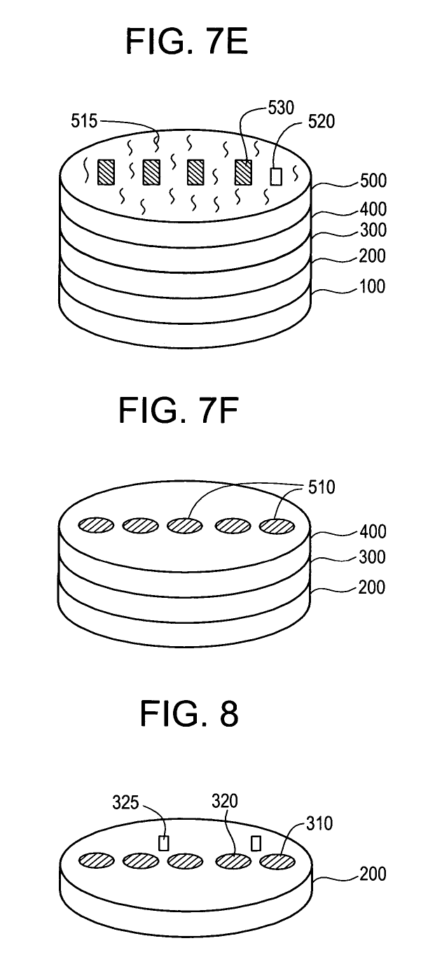

FIGS. 7a-7f illustrate another embodiment of an active device fabricated according to the invention. The active device fabricated as shown in FIGS. 7a-7f is an active 3-dimensional device having sealed recesses. In FIGS. 7a-7f the master mold 100 is non-patterned. An initial bio-degradable polymer 200 is spun or cast onto the master mold 100. The polymer 200 is cured and planarized while in the master mold 100. Thereafter, a conductive metal layer 300, for example, is deposited atop the planarized surface of the initial polymer layer 200. The metal layer 300 is then cured and planarized. A photoresist layer 400 is then applied to the planarized metal layer 300. The photoresist can be dip-coated, spray-coated, screen-printed, air-brushed or rotisseried onto the metal layer 300. The photoresist layer 400 is then masked and exposed using conventional photo-lithography techniques to produce recesses 410 in the photoresist layer 400. The recesses 410 are then filled with one or more drugs or other bio-active agents, as desired, using a standard micro-injection syringe, for example. A second polymer layer 500 is then spun or otherwise cast over the filled recessed areas 410 to provide a corresponding seal 510 for the recesses 410. Prior to curing, the second polymer 500 is doped with conductive materials and sensors 520 are embedded therein. As before, the conductive materials are preferably bio-degradable materials such as, but not limited to, gold, platinum, titanium and carbon. In each case, the conductive materials may be doped into the polymer, or sputtered, evaporated, screen-printed, or inkjet printed onto the polymer as also outlined above. Electrodes 530 are then provided on the surface of the second polymer layer 510 after curing and planarization thereof. The electrodes 530 may be sputtered, evaporated, screen-printed or inkjet deposited onto the second polymer 510. The device is then removed from the second master mold 100 and stored for future use, similar to as in earlier embodiments. In use, the drugs or other agents are released as the conductive materials of the seals 510 degrade by activation of the electrodes 530, also similar to as in other active device embodiments. Of course if the master mold 100 were patterned, then the polymer 200 deposited thereon would be inversely patterned as before.

Photo-lithographically depositing the additional layers to the underlying 2-dimensional device in this manner is understood in the art as representing one version of a 3-dimensional device. Of course, the artisan will appreciate that the additional layers need not contain recessed areas, but could instead contain any variety of patterns as desired using the same or similar processing steps as outlined above.

In still other embodiments of the systems and methods of the invention, the device fabricated is a combination active and passive device using generally various of the techniques outlined above. In this case, the active component of the device comprises the conductive bio-degradable seals 310 or 510 fabricated as described above to contain the drugs or other agents within the respective recessed areas 210 or 410, wherein the seals 210 or 510 are provided with the embedded sensors and topical electrodes as also described above. In addition, the bio-degradable polymer 20 or 200 is impregnated with the one or more drugs or other bio-active agents similar to as described above. In use therefore, the seals are actively degraded according to the signal provided to the electrodes to deliver a relatively large dose of the drug or agent from the recessed areas by the active component of the device.

During and thereafter the delivery of the large dose via active degradation of the seals, the impregnated polymer continuously degrades to passively release the one or more drugs or agents contained therein. Ideally, the drugs that are passively release will be released over a longer period of time. Of course, the artisan will appreciate that the order of the active and passive delivery of drugs can be reverse that as described herein.

In the various 2-dimensional and 3-dimensional planar embodiments of the systems and methods of the invention described herein, the master mold may be coated with a release agent prior to introduction of the polymer to the master mold.

The release agent may be used to ease the subsequent release of the polymer from the master mold substrate after the curing and planarization steps have occurred.

The release agent can be gold, parylene, or other known or later developed release agent so as to minimize damage to the master mold and/or to the device when the cured, planarized bio-degradable polymeric device is removed from the master mold.

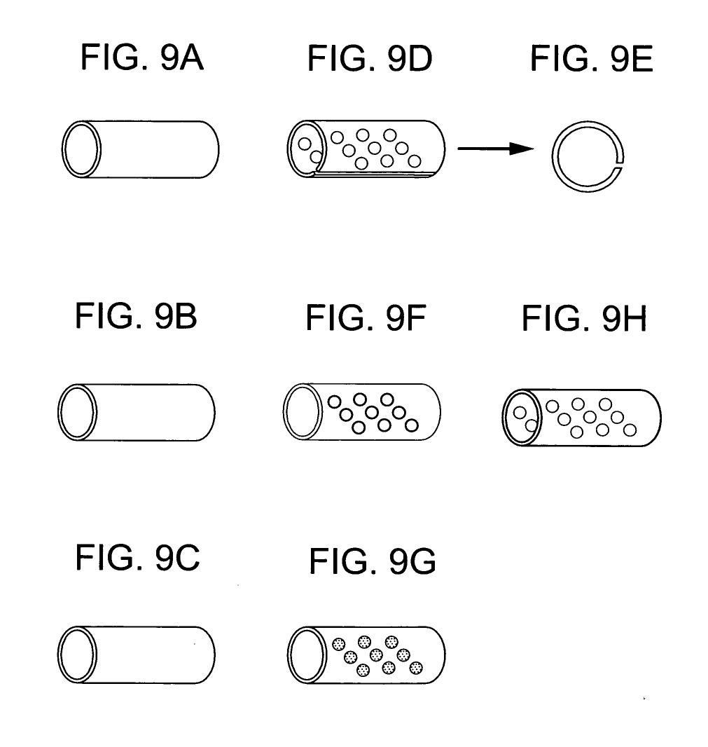

Although the various devices comprised of bio-degradable polymer and fabricated as shown in FIGS. 1a-8 are generally fabricated as 2-dimensional planar devices or 3-dimensional planar devices comprised of additional subsequent layers imposed upon an underlying 2-dimensional planar device, the artisan will appreciate that 3-dimensional non-planar devices can also be fabricated directly according to the systems and methods of the invention described herein with respect to FIGS. 9a-9h. As in the 2-dimensional planar or 3-dimensional planar devices, the 3-dimensional non-planar devices may be fabricated as passive, active or combination active-passive devices.

FIGS. 9a-9h illustrates a 3-dimensional non-planar device fabricated according to the systems and methods of the invention. FIG. 9a, for example, illustrates a sacrificial non-planar substrate 1000. The sacrificial substrate 1000 is coated with a bio-degradable film 2000. The bio-degradable film 2000 can be, but is not limited to, polymers or metals. The bio-degradable film 2000 is cured and then coated with a patternable sacrificial layer 3000. The sacrificial layer 3000 can be, but is not limited to, photoresist. The photoresist can be applied by dip-coating, spray-coating, screen-printing, air-brushing or rotisserieing as discussed in earlier described embodiments. Thereafter, in FIG. 9d, the sacrificial layer 3000 is masked with a sleeved mask 4000 having the desired pattern 4001 the non-planar device is to have upon completion. The mask 4000 exposes only those portions of the underlying sacrificial layer 3000 that are to be developed into the intended pattern.

FIG. 9e shows the mask 4000 in cross-sectional view. The mask 4000 includes a lengthwise slit 4002 intended to ease removal of the mask 4000 after the desired patterning of the sacrificial layer 3000 is achieved. The masked sacrificial layer is then developed in FIG. 9f and etched in FIG. 9g, whereafter the mask 400 is removed resulting in a 3-dimensional non-planar device with the desired pattern in FIG. 9h.

Where the non-planar device is intended to be a passive device, the polymer 2000 may be impregnated with one or more drugs or other bio-active agents prior to curing of the polymer 2000. In use, the one or more drugs or other agents are released as the polymer naturally degrades.

Where the non-planar device is intended to be an active device, the polymer 2000 may be impregnated, as before, and further doped with conductive bio-degradable materials prior to curing of the polymer 2000. As before, the conductive bio-degradable materials may be, but are not limited to, gold, titanium, platinum and carbon. As also before, the conductive materials can be doped into the polymer, or sputtered, evaporated, screen-printed or inkjet printed onto the polymer. Additionally, prior to curing of the polymer 2000, sensors may be embedded within the polymer 2000. After curing, electrodes may be provided on the polymer 2000 by sputtering, evaporating, screen-printing or inkjet depositing the electrodes onto the polymer 2000. In use, the one or more drugs or other agents are released as the conductive materials are energized by a voltage signal from the electrodes, for example, as when one or more of the sensors senses a physiological parameter that varies sufficiently from a designated threshold.

Of course, the artisan will appreciate that other variations of the 3-dimensional non-planar device are also available, wherein additional layers are photo-lithographically imposed upon the non-planar device. The artisan will also appreciate that a combination active-passive non-planar device is readily available by impregnating the polymer 2000 with the one or more drugs or other agents in combination with doping the polymer with the conductive bio-degradable materials, embedded sensors and topical electrodes as described above. In this latter case, the one or more drugs would thus be actively released as the conductive materials are energized by the electrodes, and would be passively released as the polymer otherwise naturally degrades.

In the embodiments wherein an active device is fabricated, it is anticipated that an external controller may be worn by the patient, for example, to wirelessly transmit a signal from the controller to the electrodes in order to degrade the sealing membranes or conductively doped polymer accordingly. Of course, the artisan will readily appreciate that the active devices described herein as comprised solely of electrical or conductive components, could alternatively be comprised solely of chemical or mechanical components, or could alternatively be comprised of combinations of electrical, chemical and mechanical components similarly deployed within the various structures of the device according to the systems and methods of the invention.

The various exemplary embodiments of the invention as described hereinabove do not limit different embodiments of the present invention. The material described herein is not limited to the materials, designs, or shapes referenced herein for illustrative purposes only, and may comprise various other materials, designs or shapes suitable for the systems and procedures described herein as should be appreciated by one of ordinary skill in the art, wherein the overall thickness of the device ranges from angstroms to millimeters.

Ideally, the processes described herein require minimal equipment as the mold substrates are generally reusable. The processes are highly reproducible therefore and can be readily applied to diverse applications in in vivo biology and medicine.

While there has been shown and described what is considered to be preferred embodiments of the invention, it will, of course, be understood that various modifications and changes in form or detail could readily be made without departing from the spirit or scope of the invention. It is therefore intended that the invention be not limited to the exact forms described and illustrated herein, but should be construed to cover all modifications that may fall within the scope of the appended claims.

What is claimed is:

1. ethod of micro-fabricating a bio-degradable polymer as a 2-dimensional planar medical device, the method comprising:
Providing a master mold;
Depositing a bio-degradable polymer onto the master mold;
Curing the bio-degradable polymer;
Planarizing the bio-degradable polymer to complete formation of the medical device; and
Removing the medical device from the master mold and storing the medical device until desired.

2. The method of claim 1, wherein providing the master mold further comprises providing a photo-lithographically patterned master mold, the pattern being inversely imparted to the bio-degradable polymer deposited thereon.

3. The method of claim 2, wherein depositing the bio-degradable polymer further comprises spinning or casting the bio-degradable polymer onto the master mold.

4. The method of claim 3, further comprising impregnating the biodegradable polymer with one or more drugs or bio-active agents prior to curing.

5. The method of claim 4, further comprising incorporating sensors in the bio-degradable polymer that cause the release of the one or more drugs or bio-active agents when a parameter in excess of a pre-set threshold is sensed.

6. The method of claim 5, wherein the sensors are at least one of hydrogel or foam-based sensors or chemical sensors.

7. The method of claim 4, further comprising:
impregnating the bio-degradable polymer with conductive components and embedding sensors in the bio-degradable polymer prior to curing thereof; and providing electrodes onto the surface of the bio-degradable polymer after curing thereof, the electrodes providing a signal to activate the conductive components and degrade the bio-degradable polymer to release the one or more drugs or bio-active agents when a physiological parameter detected by the embedded sensors is beyond a designated threshold.

8. The method of claim 3, wherein the inversely imparted pattern provided to the bio-degradable polymer further comprises providing recesses to the bio-degradable polymer, the recesses being filled with one or more drugs or bio-active agents after curing of the bio-degradable polymer.

9. The method of claim 8, further comprising providing a seal to the recesses after the recesses have been filled with the one or more drugs or bio-active agents.

10. The method of claim 9, wherein providing the seals further comprises:
Providing a second master mold with a photo-lithographically imposed pattern corresponding to the filled recesses of the cured bio-degradable polymer;
Placing the cured bio-degradable polymer with filled recesses adjacent the second master mold; and
Photo-lithographically imparting the pattern of the second master mold to the cured bio-degradable polymer to provided the seals to the filled recesses.

11. The method of claim 10, wherein providing the seals further comprises providing the seals made of bio-degradable materials.

12. The method of claim 11, wherein providing the seals further comprising providing the seals of different thicknesses, the thickness of the seals determining the rate of degradation of the resepective seals.

13. The method of claim 12, further comprising impregnating the biodegradable polymer with one or more drugs or bio-active agents prior to curing.

14. The method of claim 13, further comprising:
impregnating the bio-degradable polymer with conductive components and embedding sensors in the bio-degradable polymer prior to curing thereof; and
providing electrodes onto the surface of the bio-degradable polymer after curing thereof, the electrodes providing a signal to activate the conductive components and degrade the bio-degradable polymer to release the one or more drugs or bio-active agents when a physiological parameter detected by the embedded sensors is beyond a designated threshold.

15. The method of claim 13, wherein the seals and the bio-degradable polymer degrade at different rates to control the rate of release of the one or more drugs or bio-active agents contained therein.

16. A method of micro-fabricating a bio-degradable polymer as a 3-dimensional planar medical device, the method comprising:
Providing a master mold;
Depositing a first bio-degradable polymer onto the master mold;
Curing the first bio-degradable polymer;
Planarizing the first bio-degradable polymer;
Depositing a metal layer onto the cured first bio-degradable polymer;
Curing the metal layer;
Planarizing the metal layer;
Depositing a photo-resist layer atop the planarized metal layer;
Masking the photo-resist layer;
Exposing the photo-resist layer to produce recesses in the photo-resist layer;
Filling the recesses with one or more drugs or bio-active agents;
Depositing a second bio-degradable polymer over the filled recesses to provide seals therefor;
Curing the second bio-degradable polymer;
Planarizing the second bio-degradable polymer, thereby completing formation of the medical device; and
Removing the medical device from the master mold and storing the medical device until desired.

17. The method of claim 16, wherein exposing the photo-resist layer to produce the recesses further comprises producing a pattern in the photo-resist layer into which the one or more drugs or bio-active agents can be received.

18. The method of claim 17, further comprising impregnating at least one of the first bio-degradable polymer and the second bio-degradable polymer with one or more drugs or bio-active agents prior to curing.

19. The method of claim 18, wherein the seals, the first bio-degradable polymer and the second bio-degradable polymer degrade at different rates to control the rate of release of the one or more drugs or bio-active agents contained therein.

20. The method of claim 19, further comprising:
doping the seals or the second bio-degradable polymer with conductive components prior to curing of the second bio-degradable polymer; and
embedding sensors in the seals or the second bio-degradable polymer prior to curing thereof; and
providing electrodes on the surface of the planarized second bio-degradable polymer after curing thereof, the electrodes providing a signal to activate the conductive components and degrade the seals or the second bio-degradable polymer when a physiological parameter detected by the embedded sensors is beyond a designated threshold.

21. The method of claim 20, wherein the electrodes are deposited onto the second biodegradable polymer by one of sputtering, evaporation, screen-printing or inkjetting.

22. The method of claim 20, wherein only the seals are doped with the conductive components and the second bio-degradable polymer is impregnated with the one or more drugs or bio-active agents prior to curing of the second bio-degradable polymer.

23. A method of micro-fabricating a bio-degradable polymer as 3-dimensional non-planar medical device, the method comprising:
Providing a sacrificial non-planar substrate;
Coating the substrate with a bio-degradable film;
Curing the film;
Coating the film with a patternable sacrificial layer;
Masking the sacrificial layer, the mask providing the intended pattern the medical device is to ultimately exhibit;
Exposing the sacrificial layer to light to develop the intended pattern;
Removing the mask to complete formation of the medical device; and
Storing the medical device until desired.

24. The method of claim 23, further comprising impregnating the bio-degradable film with one or more drugs prior to curing thereof, wherein a rate of release of the one or more drugs or bio-active agents depends on a rate of degradation of the bio-degradable film.

25. The method of claim 24, wherein the bio-degradable film is a polymer.

26. The method of claim 24, further comprising;
doping the biodegradable film with conductive components prior to curing of the film;
embedding sensors in the film prior to curing thereof; and
providing electrodes on the film after curing thereof, the electrodes providing a signal to activate the conductive components and degrade the second bio-degradable polymer when a physiological parameter detected by the embedded sensors is beyond a designated threshold.

27. The method of claim 26, wherein the rate of release of the one or more drugs or bio-active agents depends on the rate of degradation of the bio-degradable film and the signal provided from the electrodes.

28. The method of claim 26, wherein the electrodes are deposited on the fim by one of sputtering, evaporation, screen-printing or inkjetting.

29. The method of claim 1, wherein the master mold is formed by one of photolithography, laser etching, mold casting or machining.

30. The method of claim 1, wherein the master mold is sacrificial.

31. The method of claim 1, wherein the master mold is permanent.

32. The method of claim 7, wherein the conductive components are doped into the bio-degradable polymer.

33. The method of claim 7, wherein the conductive components are doped onto the biodegradable polymer by one of evaporating, sputtering or screen-printing, or inkjet printing.

34. The method of claim 7, further comprising providing at least one of chemical or mechanical components in combination with the conductive components and electrodes to activate the device and degrade the bio-degradable polymer.

35. The method of claim 16, wherein the master mold is sacrificial.

36. The method of claim 16, wherein the master mold is permanent.

37. The method of claim 20, wherein the conductive components are doped into the bio-degradable polymer.

38. The method of claim 20, wherein the conductive components are doped onto the bio-degradable polymer by one of evaporating, sputtering or screen-printing, or inkjet printing.

39. The method of claim 20, further comprising providing at least one of chemical or mechanical components in combination with the conductive components and electrodes to activate the device and degrade the bio-degradable polymer.

40. The method of claim 16, wherein the photoresist is applied by one of dip-coating, spray-coating, screen-printing, or inkjet printing, airbrushing or rotisserieing the photoresist onto the metal layer.

41. The method of claim 23, wherein the sacrificial layer is applied by one of dip-coating, spray-coating, screen-printing, or inkjet printing, airbrushing or rotisserieing the photoresist onto the metal layer.

42. The method of claim 41, wherein the sacrificial layer is photoresist.

43. The method of claim 26, wherein the conductive components are doped into the bio-degradable polymer.

44. The method of claim 26, wherein the conductive components are doped onto the bio-degradable polymer by one of evaporating, sputtering or screen-printing, or inkjet printing.

45. The method of claim 26, further comprising providing at least one of chemical or mechanical components in combination with the conductive components and electrodes to activate the device and degrade the bio-degradable polymer.
